(19) United States
(12) Patent Application Publication
(10) Pub. No.: US 2015/0042661 A1
(43) Pub. Date: Feb. 12, 2015

(54) HANDWRITTEN DOCUMENT PROCESSING DEVICE, HANDWRITTEN DOCUMENT PROCESSING METHOD, AND HANDWRITTEN DOCUMENT PROCESSING PROGRAM

(71) Applicant: Kabushiki Kaisha Toshiba, Tokyo (JP)

(72) Inventors: Kazunori IMOTO, Kawasaki-shi (JP); Toshiaki NAKASU, Shinagawa-ku (JP)

(21) Appl. No.: 14/452,349

(22) Filed: Aug. 5, 2014

(30) Foreign Application Priority Data
Aug. 9, 2013 (JP) 2013-166367

(51) Int. Cl. G09G 5/24

(52) U.S. Cl. CPC G09G 5/24
USPC 345/467

(57) ABSTRACT

According to one embodiment, a handwritten document processing device includes an input/output unit and a processing unit. The input/output unit acquires a plurality of sets of stroke data of a handwritten document. The sets of stroke data include a first portion including first stroke data, a second portion including second stroke data, and a third portion including third stroke data. The processing unit is capable of implementing a first processing operation of deriving first table data based on the sets of stroke data and supplying the first table data to the input/output unit. The first table data include a first ruled line corresponding to the first portion, first cell data corresponding to the second portion, second cell data corresponding to the third portion, and a second ruled line provided between the first cell data and the second cell data.

### CROSS-REFERENCE TO RELATED APPLICATIONS

This application is based upon and claims the benefit of priority from Japanese Patent Application No. 2013-166367, filed on Aug. 9, 2013; the entire contents of which are incorporated herein by reference.

### FIELD

Embodiments described herein relate generally to a handwritten document processing device, a handwritten document processing method, and a handwritten document processing program.

### BACKGROUND

Information including a table is handwritten electronically using, for example, a pen input interface, etc. The handwritten table is appropriately processed to format the table. It is desirable to be able to format a table that has been more freely handwritten.

### BRIEF DESCRIPTION OF THE DRAWINGS

FIG. 1 is a schematic view showing a handwritten document processing device according to a first embodiment;

FIG. 2 is a schematic view showing stroke data of the handwritten document processing device according to the first embodiment;

FIG. 3 is a schematic view showing the processing result of the handwritten document processing device according to the first embodiment;

FIG. 4 is a schematic view showing another processing result of the handwritten document processing device according to the first embodiment;

FIG. 5 is a flowchart showing operations of the handwritten document processing device according to the first embodiment;

FIG. 6A and FIG. 6B are schematic views showing a portion of the operations of the handwritten document processing device according to the first embodiment;

FIG. 7 is a schematic view showing a portion of the operations of the handwritten document processing device according to the first embodiment;

FIG. 8 is a schematic view showing a portion of the operations of the handwritten document processing device according to the first embodiment;

FIG. 9A and FIG. 9B are schematic views showing a portion of the operations of the handwritten document processing device according to the first embodiment;

FIG. 10 is a schematic view showing other stroke data of the handwritten document processing device according to the first embodiment;

FIG. 11 is a schematic view showing a portion of the operations of the handwritten document processing device according to the first embodiment;

FIG. 12 is a schematic view showing a portion of the operations of the handwritten document processing device according to the first embodiment;

FIG. 13 is a schematic view showing a portion of the operations of the handwritten document processing device according to the first embodiment;

FIG. 14A and FIG. 14B are schematic views showing a portion of the operations of the handwritten document processing device according to the first embodiment;

FIG. 15 is a schematic view showing other stroke data of the handwritten document processing device according to the first embodiment;

FIG. 16 is a schematic view showing a portion of the operations of the handwritten document processing device according to the first embodiment;

FIG. 17 is a schematic view showing a portion of the operations of the handwritten document processing device according to the first embodiment;

FIG. 18 is a schematic view showing a portion of the operations of the handwritten document processing device according to the first embodiment;

FIG. 19A to FIG. 19C are schematic views showing a portion of the operations of the handwritten document processing device according to the first embodiment;

FIG. 20 is a schematic view showing other stroke data of the handwritten document processing device according to the first embodiment;

FIG. 21 is a schematic view showing a portion of the operations of the handwritten document processing device according to the first embodiment;

FIG. 22A and FIG. 22B are schematic views showing processing results of the handwritten document processing device according to the first embodiment;

FIG. 23 is a schematic view showing data used in the handwritten document processing device according to the first embodiment;

FIG. 24 is a schematic view showing the handwritten document processing device according to the first embodiment;

FIG. 25 is a schematic view showing the handwritten document processing device according to the first embodiment; and

FIG. 26 is a flowchart showing the operations of the handwritten document processing device according to the first embodiment.

### DETAILED DESCRIPTION

According to one embodiment, a handwritten document processing device includes an input/output unit and a processing unit. The input/output unit is configured to acquire a plurality of sets of stroke data of a handwritten document. The sets of stroke data include a first portion, a second portion, and a third portion. The first portion includes first stroke data. The second portion includes second stroke data. The third portion includes third stroke data. The processing unit is capable of implementing a first processing operation of deriving first table data based on the sets of stroke data acquired by the input/output unit and supplying the first table data to the input/output unit. The first table data include a first ruled line, first cell data, second cell data, and a second ruled line. The first ruled line corresponds to the first portion. The first cell data correspond to the second portion. The second cell data correspond to the third portion. The second ruled line is provided between the first cell data and the second cell data.

Various embodiments will be described hereinafter with reference to the accompanying drawings.

The drawings are schematic or conceptual; and the proportions of sizes between portions, etc., are not necessarily the same as the actual values thereof. Further, the dimensions and/or the proportions may be illustrated differently between the drawings, even for identical portions.

In the drawings and the specification of the application, components similar to those described in regard to a drawing thereinabove are marked with like reference numerals, and a detailed description is omitted as appropriate.

### First Embodiment

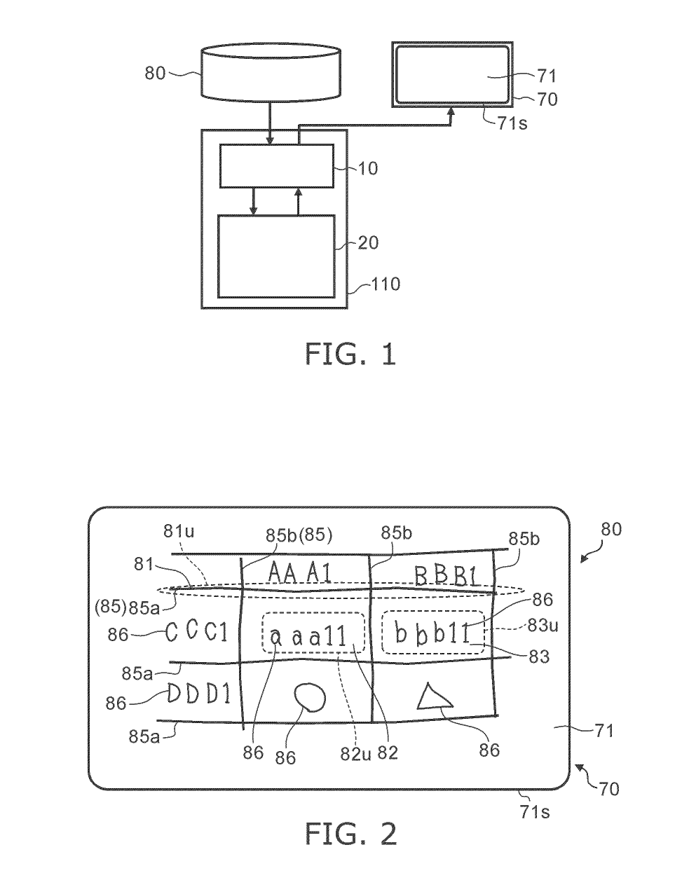

FIG. 1 is a schematic view showing a handwritten document processing device according to a first embodiment.

As shown in FIG. 1, the handwritten document processing device 110 according to the embodiment includes an input/output unit 10 and a processing unit 20.

The processing unit 20 includes, for example, a semiconductor device such as an arithmetic unit, etc. The processing unit 20 includes, for example, a computer. The input/output unit 10 includes, for example, a terminal of a semiconductor device, etc. The input/output unit 10 may include a terminal (including an interface) of a computer.

The input/output unit 10 acquires data. Any wired or wireless method is used in the acquisition of the data by the input/output unit 10. The data that is acquired includes, for example, multiple sets of stroke data 80 of the handwritten document. Examples of the stroke data 80 are described below.

The processing unit 20 performs processing based on the multiple sets of stroke data 80 acquired by the input/output unit 10. The processing unit 20 supplies the result (the data) of the processing to the input/output unit 10.

A display unit 70 is connectable to the handwritten document processing device 110. For example, the display unit 70 is connected to the input/output unit 10. The display unit 70 includes, for example, a liquid crystal display device, an organic EL display device, a projection-type display device, etc. The display unit 70 may include a printer. In the embodiment, “displaying” also includes printing. In the embodiment, the display unit 70 is arbitrary. The display unit 70 includes a display region 71. In the case where a printer is used as the display unit 70, the display region 71 corresponds to a printable region. The display region 71 has, for example, a side 71s.

The stroke data 80 is displayable by the display unit 70. The result (the data) of the processing of the processing unit 20 is displayable by the display unit 70. Hereinbelow, an example of a state is described in which the stroke data 80 and the result (the data) of the processing are displayed by the display unit 70.

FIG. 2 is a schematic view showing stroke data of the handwritten document processing device according to the first embodiment.

As shown in FIG. 2, the multiple sets of stroke data 80 include, for example, information having a table form. A user inputs the table by, for example, handwriting on a tablet for input. For example, a pen, a finger, or the like is used for the input.

The multiple sets of stroke data 80 include, for example, ruled line input data 85. In the example, the ruled line input data 85 includes horizontal ruled line input data 85a and vertical ruled line input data 85b. The multiple sets of stroke data 80 further include non-ruled line input data 86. In the example, multiple sets of non-ruled line input data 86 are provided. The ruled line input data 85 has a line configuration. The ruled line input data 85 corresponds to at least a portion of the ruled lines of the table. The non-ruled line input data 86 corresponds to the data inside the cells of the table.

For example, the non-ruled line input data 86 includes at least one selected from character information and shape information. In the example, the character information of “AAA1,” “BBB1,” “CCC1,” “aaa11,” “bbb11,” and “DDD1” is provided. Further, the shape information of “O” and “Δ” is provided.

The multiple sets of stroke data 80 include, for example, a first portion 81u, a second portion 82u, and a third portion 83u.

The first portion 81u corresponds to at least a portion of the ruled line input data 85 (in the example, the horizontal ruled line input data 85a). The first portion 81u includes first stroke data 81. The first stroke data 81 has a line configuration.

The second portion 82u corresponds to at least a portion of the non-ruled line input data 86. The second portion 82u includes second stroke data 82. The second stroke data 82 includes, for example, at least a portion of the character information and at least a portion of the shape information.

The third portion 83u corresponds to at least a portion of the non-ruled line input data 86. The third portion 83u includes third stroke data 83. The third stroke data 83 includes, for example, at least a portion of the character information and at least a portion of the shape information.

The multiple sets of stroke data 80 of such a handwritten document are supplied to the input/output unit 10.

The multiple sets of stroke data 80 include, for example, multiple sets of time series data. For example, the multiple sets of time series data correspond respectively to multiple strokes of handwriting. Each stroke includes multiple coordinates.

One set of stroke data includes, for example, the data of (x(1, 1), y(1, 1)), (x(1, 2), y(1, 2)), . . . , and (x(1, N(1)), y(1, N(1))). Another set of stroke data includes the data of (x(2, 1), y(2, 1)), (x(2, 2), y(2, 2)), . . . , and (x(2, N(2)), y(2, N(2))). Here, N(i) is the number of points of the sampling for the ith stroke. The stroke data corresponds to handwritten data of the handwritten input. Examples of the data structure of the stroke data are described below.

The processing unit 20 implements a processing operation based on the multiple sets of stroke data 80 acquired by the input/output unit 10. A first processing operation is described as an example.

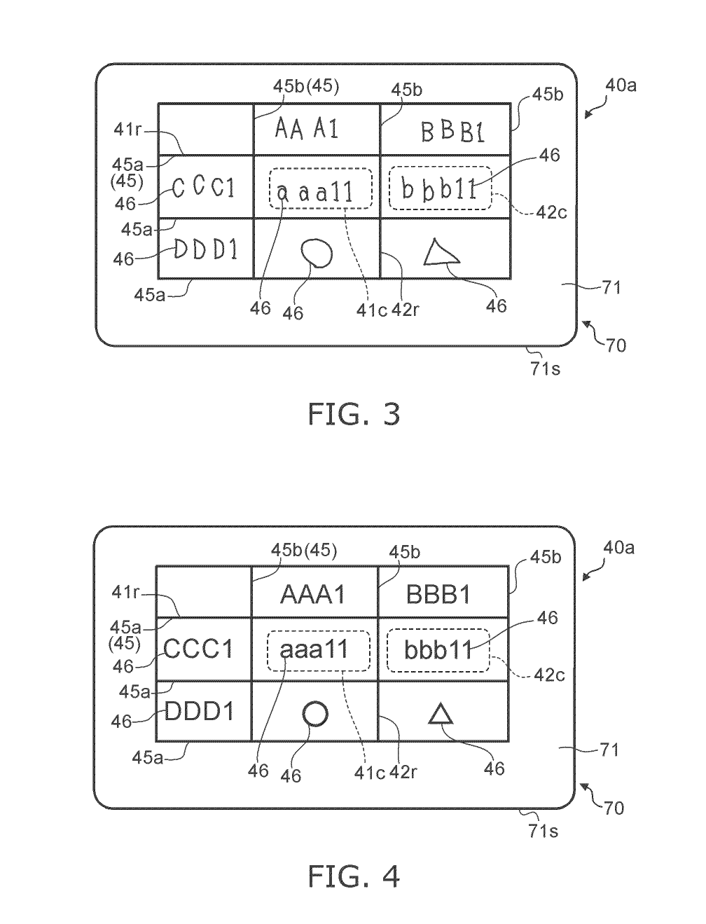

FIG. 3 is a schematic view showing the processing result of the handwritten document processing device according to the first embodiment.

FIG. 3 shows table data (first table data 40a) derived by the processing of the processing unit 20.

As shown in FIG. 3, for example, the first table data 40a includes ruled line output data 45. In the example, the ruled line output data 45 includes, for example, horizontal ruled line output data 45a and vertical ruled line output data 45b. The first table data 40a further includes non-ruled line output data 46. In the example, multiple sets of non-ruled line output data 46 are provided. The ruled line output data 45 has a line configuration. The ruled line output data 45 corresponds to at least a portion of the ruled lines of the first table data 40a. The non-ruled line output data 46 corresponds to the data inside the cells of the first table data 40a. At least a portion of the ruled line output data 45 corresponds to at least a portion of the ruled line input data 85. At least a portion of the non-ruled line output data 46 corresponds to at least a portion of the non-ruled line input data 86.

For example, the non-ruled line output data 46 includes first cell data 41c and second cell data 42c. The first cell data 41c corresponds to the second portion 82u of the multiple sets of stroke data 80. The second cell data 42c corresponds to the third portion 83u of the multiple sets of stroke data 80. In the example, the first cell data 41c and the second cell data 42c are arranged in the horizontal direction of the table.

For example, the ruled line output data 45 includes a first ruled line 41r and a second ruled line 42r. The first ruled line 41r corresponds to the first portion 81u of the multiple sets of stroke data 80. The second ruled line 42r is provided between the first cell data 41c and the second cell data 42c. In the example, the first ruled line 41r corresponds to one of the horizontal ruled lines of the table. The second ruled line 42r corresponds to one of the vertical ruled lines of the table. For example, the first ruled line 41r is substantially parallel to the extension direction of the first portion 81u.

In the embodiment, the first cell data 41c and the second cell data 42c may be arranged in the vertical direction of the table. In such a case, the second ruled line 42r corresponds to one of the horizontal ruled lines of the table.

Thus, in the first processing operation implemented by the processing unit 20, the processing unit 20 derives the first table data 40a based on the multiple sets of stroke data 80 acquired by the input/output unit 10 and supplies the first table data 40a to the input/output unit 10, where the first table data 40a includes the first ruled line 41r corresponding to the first portion 81u, the first cell data 41c corresponding to the second portion 82u, the second cell data 42c corresponding to the third portion 83u, and the second ruled line 42r. The second ruled line 42r is provided between the first cell data 41c and the second cell data 42c.

The first portion 81u that is input by handwriting has a line configuration but is not necessarily a straight line. Conversely, in the example, the first ruled line 41r that corresponds to the first portion 81u has a straight line configuration. In the example, the first cell data 41c is stroke data of the second portion 82u of the multiple sets of stroke data 80 that are input by handwriting. The second cell data 42c is stroke data of the third portion 83u of the multiple sets of stroke data 80 that are input by handwriting. In the embodiment, the cell data (the non-ruled line output data 46) may be stroke data that is converted.

FIG. 4 is a schematic view showing another processing result of the handwritten document processing device according to the first embodiment.

In the example as shown in FIG. 4, the non-ruled line output data 46 is data that is derived (made) based on the non-ruled line input data 86. The non-ruled line output data 46 is obtained by, for example, converting the non-ruled line input data 86. For example, pattern recognition of the non-ruled line input data 86 is performed; and the non-ruled line output data 46 is obtained based on the pattern recognition data. The non-ruled line output data 46 includes, for example, the information of character fonts, etc.

For example, the first cell data 41c is data that is derived (made) based on the stroke data of the second portion 82u. The second cell data 42c is data that is derived (made) based on the stroke data of the second portion 82u.

Thus, the cell data (the non-ruled line output data 46) may include stroke data that is converted.

An example of the processing included in the first processing operation will now be described.

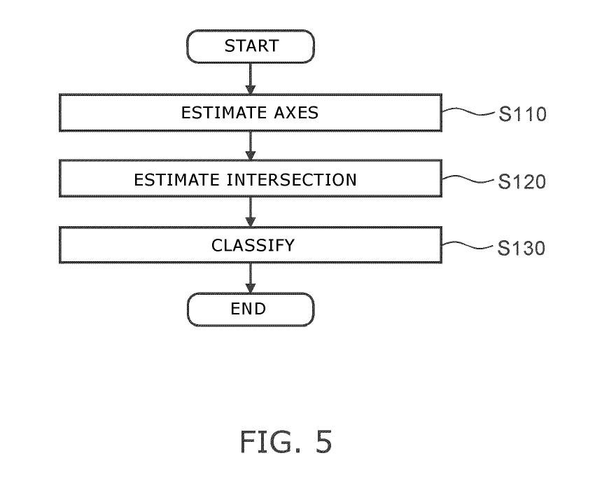

FIG. 5 is a flowchart showing operations of the handwritten document processing device according to the first embodiment.

As shown in FIG. 5, the first processing operation includes, for example, axis estimation processing (step S110), intersection estimation processing (step S120), and classification processing (step S130).

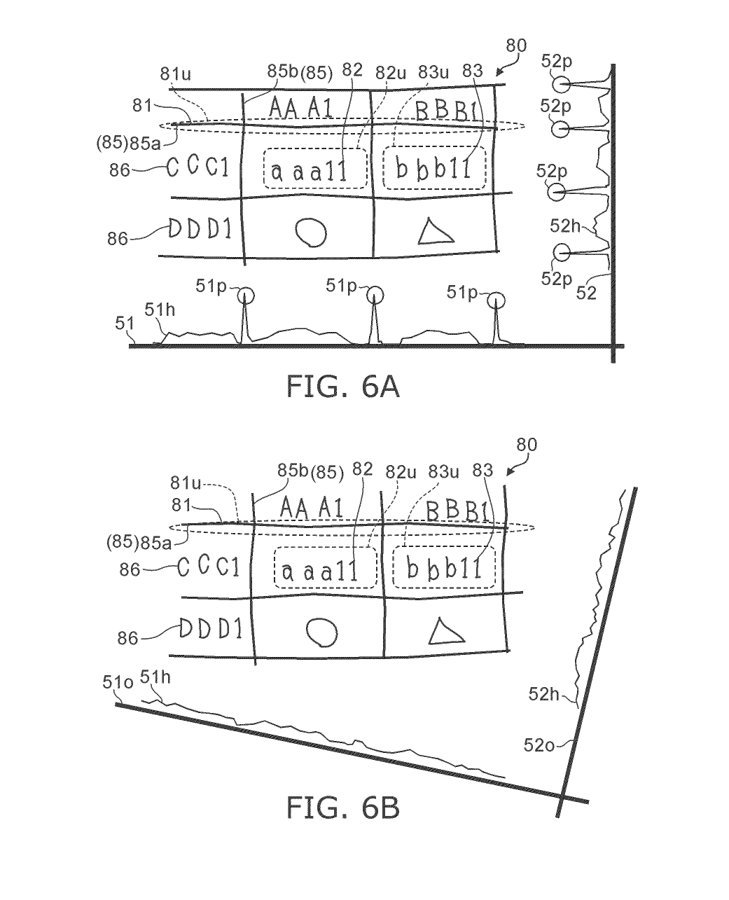

FIG. 6A and FIG. 6B are schematic views showing a portion of the operations of the handwritten document processing device according to the first embodiment.

These drawings show axis estimation processing.

As shown in FIG. 6A, the axis estimation processing estimates a first axis 51 and a second axis 52. The second axis 52 is perpendicular to the first axis 51. For example, the second axis 52 is orthogonal to the first axis. The first axis 51 and the second axis 52 are provided in the plane that is input by handwriting. For example, when the stroke data 80 is displayed by the display unit 70, the first axis 51 and the second axis 52 are provided in the plane of the display region 71 of the display unit 70.

For example, the first axis 51 is the major axis of the table; and the second axis 52 is the minor axis of the table. The first axis 51 may be the minor axis of the table; and the second axis 52 may be the major axis of the table.

In the table, the vertical ruled lines and the horizontal ruled lines are drawn to be orthogonal. The major axis extends along one selected from the direction of the vertical ruled lines and the direction of the horizontal ruled lines. The minor axis extends along the other selected from the direction of the vertical ruled lines and the direction of the horizontal ruled lines.

For example, the stroke data (i.e., the ruled line input data 85, and in the example, the horizontal ruled line input data 85a) that corresponds to the ruled lines has a component perpendicular to the second axis 52. When the perpendicular component is projected onto the second axis 52, the component concentrates at designated coordinates on the second axis 52. In other words, peaks 52p of the projection component occur on the second axis 52.

For example, the stroke data (i.e., the ruled line input data 85, and in the example, the vertical ruled line input data 85b) that corresponds to the ruled lines has a component perpendicular to the first axis 51. When the perpendicular component is projected onto the first axis 51, the component concentrates at designated coordinates on the first axis 51. In other words, peaks 51p of the projection component occur on the first axis 51.

On the other hand, when the component of the stroke data that corresponds to the ruled lines is projected onto a tilted axis that is tilted with respect to the vertical ruled lines or the horizontal ruled lines, the projection component is projected onto a wide range of coordinates. Therefore, the peaks of the projection component are indistinct. For example, smooth hills and valleys occur. By focusing on this aspect, the directions of the axes of the table can be estimated using the peaks of the projection components of the stroke data onto the axes as the determination standard.

For example, in the axis estimation processing, an axis that is a candidate for the major axis is rotated in a range of 0 degrees to 180 degrees; and the projection component is determined. For example, the axis that is the candidate for the major axis is rotated at a spacing of a prescribed angle. An axis that is a candidate for the minor axis also is rotated in conjunction with the rotation of the axis that is the candidate for the major axis.

As shown in FIG. 6B, the axis estimation processing sets a first candidate axis 51o and a second candidate axis 52o. The second candidate axis 52o is perpendicular to the first candidate axis 51o. In the example, the first candidate axis 51o and the second candidate axis 52o are tilted with respect to the axes of the table.

A distinct peak does not occur for cumulative projection component 51h of the projection component of the multiple sets of stroke data 80 onto the first candidate axis 51o. Similarly, a distinct peak does not occur for cumulative projection component 52h of the projection component of the multiple sets of stroke data 80 onto the second candidate axis 52o. This is because the extension direction of the first candidate axis 51o and the extension direction of the second candidate axis 52o are tilted with respect to the extension directions of the ruled line input data 85 (the horizontal ruled line input data 85a and the vertical ruled line input data 85b). In other words, the average data of the ruled line input data 85 and the non-ruled line input data 86 is projected onto the first candidate axis 51o and projected onto the second candidate axis 52o. Thereby, distinct peaks do not occur.

Conversely, as shown in FIG. 6A, the distinct peaks 51p and the distinct peaks 52p occur when the first candidate axis 51o and the second candidate axis 52o are aligned with the axes of the table.

Thus, the peaks 51p and the peaks 52p are formed in the histograms (the cumulative projection component 51h and the cumulative projection component 52h) of the cumulative components of the stroke data 80 projected onto the first candidate axis 51o and the second candidate axis 52o that extend in prescribed directions. The peaks 51p and the peaks 52p correspond to the ruled line input data 85 of the table.

As shown in FIG. 6A, the cumulative projection component 51h and the cumulative projection component 52h of the projection components of the non-ruled line input data 86 are less than the values of the peaks 51p and the peaks 52p.

Thus, the first candidate axis 51o and the second candidate axis 52o are set to extend in prescribed directions; and the heights of the peaks at this time are calculated. The angles of the directions in which the candidate axes extend are changed; and the heights of the peaks are determined at the angles. The candidate axes at the angles at which the heights of the peaks are high are used as the first axis 51 and the second axis 52.

For example, the first stroke data 81 that is included in the first portion 81u extends in a prescribed direction (in the example, the horizontal direction). In such a case, the peak values (the heights of the peaks 52p) of the cumulative projection component 52h of the projection component of the multiple sets of stroke data 80 onto the second axis 52 extending in the vertical direction are higher than the peak values of the cumulative projection component 52h of the projection component of the multiple sets of stroke data 80 onto a tilted axis (e.g., the second candidate axis 52o) tilted with respect to the second axis 52.

For example, other stroke data (e.g., the vertical ruled line input data 85b) extends in a prescribed direction (in the example, the vertical direction). In such a case, the peak values (the heights of the peaks 51p) of the cumulative projection component 51h of the projection component of the multiple sets of stroke data 80 onto the first axis 51 extending in the horizontal direction are higher than the peak values of the cumulative projection component 51h of the projection component of the multiple sets of stroke data 80 onto a tilted axis (e.g., the first candidate axis 51o) tilted with respect to the first axis 51.

Further, the peak values (the heights of the peaks 52p) of the cumulative projection component 52h of the projection component of the multiple sets of stroke data 80 onto the second axis 52 may be higher than the peak values of the cumulative projection component 51h of the projection component of the multiple sets of stroke data 80 onto the first candidate axis 51o (the tilted axis) tilted with respect to the second axis 52.

Similarly, the peak values (the heights of the peaks 51p) of the cumulative projection component 51h of the projection component of the multiple sets of stroke data 80 onto the first axis 51 may be higher than the peak values of the cumulative projection component 52h of the projection component of the multiple sets of stroke data 80 onto the second candidate axis 52o (the axis perpendicular to the tilted axis) tilted with respect to the first axis 51.

For example, the entropy is calculated from the cumulative projection component (the histogram) of the projection component of the multiple sets of stroke data 80 for the first candidate axis 51o and the second candidate axis 52o. The entropy is a measure of the randomness. The bias increases as the value of the entropy decreases. For the histogram, the value of the entropy decreases as more local peaks of the projection component exist. The axes candidates at which the entropy is lowest may be selected as the combination of the first axis 51 and the second axis 52. In other words, the axis estimation processing may include, for example, estimating the second axis 52 to minimize the entropy of the cumulative projection component 52h of the projection component of the multiple sets of stroke data 80 onto the second axis 52. For example, among the multiple candidate axes having mutually-different extension directions, the second axis 52 is estimated to minimize the entropy of the cumulative projection component 52h.

The axis estimation processing may include, for example, estimating the first axis 51 to minimize the entropy of the cumulative projection component 51h of the projection component of the multiple sets of stroke data 80 onto the first axis 51. For example, among the multiple candidate axes having mutually-different extension directions, the first axis 51 is estimated to minimize the entropy of the cumulative projection component 51h.

For example, axes directions corresponding to angles at the centers of angles of the axes candidates in a range in which entropies not less than a predetermined value are obtained may be selected as the combination of the first axis 51 and the second axis 52.

In other words, the bias of the histogram of the first axis 51 or the second axis 52 is greater than the bias of the histogram of the tilted axis. The major axis-like properties of the first axis 51 or the second axis 52 are higher than the major axis-like properties of the tilted axis.

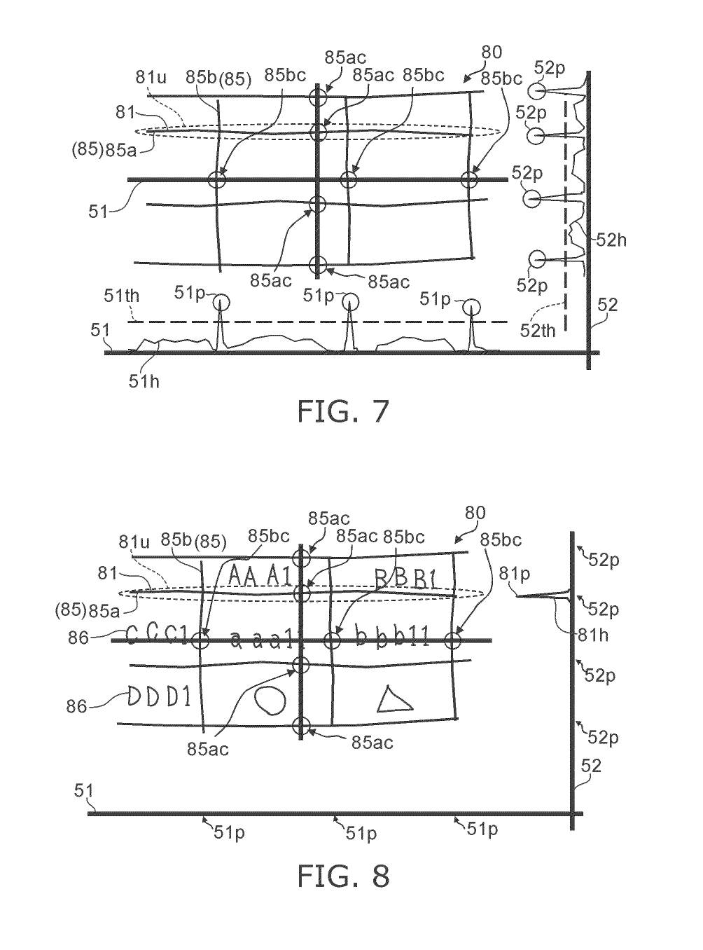

FIG. 7 is a schematic view showing a portion of the operations of the handwritten document processing device according to the first embodiment.

FIG. 7 shows intersection estimation processing. In FIG. 7, the ruled line input data 85 of the stroke data 80 is shown, and the non-ruled line input data 86 of the stroke data 80 is not shown for easier viewing of the drawing.

In the intersection estimation processing as shown in FIG. 7, for example, the positions of intersections between the first axis 51 and the ruled line input data 85 and the positions of intersections between the second axis 52 and the ruled line input data 85 are estimated. For example, the positions of intersections 85bc between the first axis 51 and the vertical ruled line input data 85b and the positions of intersections 85ac between the second axis 52 and the horizontal ruled line input data 85a are estimated.

The projection component of the stroke data corresponding to the ruled line input data 85 concentrates at designated coordinates of the axes. Therefore, the intersections can be estimated by focusing on the peaks of the histograms of the projection components.

For example, a first threshold 51th is provided for the histogram of the cumulative projection component (the cumulative projection component 51h) of the projection component of the multiple sets of stroke data 80 onto the first axis 51. The positions are determined where the values (the heights) of the peaks 51p of the histogram (the cumulative projection component 51h) are not less than the first threshold 51th. The positions (the coordinates) of the intersections 85bc are determined based on such positions.

For example, a second threshold 52th is provided for the histogram (the cumulative projection component 52h) of the cumulative projection component of the projection component of the multiple sets of stroke data 80 onto the second axis 52. The positions are determined where the values (the heights) of the peaks 52p of the histogram (the cumulative projection component 52h) are not less than the second threshold 52th. The positions (the coordinates) of the intersections 85ac are determined based on such positions.

For example, a set of coordinates is determined. For the set of coordinates, the value of the histogram continuously exceeds the threshold recited above. For example, for such a set of coordinates, the coordinates where the histogram has local maximums are the positions of intersections.

In the intersection estimation processing, for example, an intersection (at least one selected from the intersection 85ac and the intersection 85bc) is estimated based on the position of the peak 51p of the cumulative projection component 51h of the projection component of the multiple sets of stroke data 80 onto the first axis 51 and the position of the peak 52p of the cumulative projection component 52h of the projection component of the multiple sets of stroke data 80 onto the second axis 52. The at least one selected from the intersection 85ac and the intersection 85bc is the intersection between the first ruled line 41r of the first table data 40a and at least one selected from the first axis 51 and the second axis 52.

In other words, in the intersection estimation processing, at least one selected from the intersection 85ac and the intersection 85bc is estimated based on the cumulative projection component 51h of the projection component of the multiple sets of stroke data 80 onto the first axis 51 and the cumulative projection component 52h of the projection component of the multiple sets of stroke data 80 onto the second axis 52.

FIG. 8 is a schematic view showing a portion of the operations of the handwritten document processing device according to the first embodiment.

FIG. 8 shows classification processing.

In the classification processing, the multiple sets of stroke data 80 are classified into the ruled line input data 85 and the non-ruled line input data 86.

For example, each of the stroke data 80 is projected onto the first axis 51 and the second axis 52. The histogram (the cumulative projection component 81h) of the projection component of the first stroke data 81 onto the second axis 52 is shown in FIG. 8 as an example. A peak 81p occurs in the histogram (the cumulative projection component 81h). In the case where the distance between the position of the peak 81p of the projected histogram on the second axis 52 and the position of the intersection 85ac on the second axis 52 is short, the stroke (the first stroke data 81) is determined to correspond to a ruled line. The ruled line extends along a direction perpendicular to the second axis 52.

For example, in the case where the peak 81p is abrupt, the stroke (the first stroke data 81) is determined to correspond to a ruled line. For example, the peak 81p has a width at half local maximum. A threshold is pre-determined for the peak. For example, the peak 81p is determined to be abrupt in the case where the width at half local maximum of the obtained peak 81p is not more than the threshold.

For example, a threshold is determined for the distance between the position of the projected histogram on the second axis 52 and the position of the intersection on the second axis 52. For example, the distance between the position of the intersection 85ac on the second axis 52 and the position on the second axis 52 of the projection component onto the second axis 52 is determined for each of the components included in one set of stroke data 80. The one set of stroke data 80 is determined to correspond to a ruled line in the case where all of these distances determined for the one set of stroke data 80 are not more than the threshold.

For example, in the case where multiple intersections (the multiple intersections 85ac) are obtained for the second axis 52, the threshold for the distances recited above may be determined based on the local minimum value of the distances between the multiple intersections 85ac. For example, the threshold is not less than 0.05 times and not more than 0.2 times the local minimum value of the distances between the multiple intersections 85ac. For example, the threshold is 0.1 times the local minimum value of the distances between the multiple intersections 85ac.

Similarly, the stroke is determined to correspond to a ruled line in the case where the distance between the position of the peak of the projected histogram on the first axis 51 and the position of the intersection 85bc on the first axis 51 is short. For example, for the first axis 51, a threshold may be determined for the distance between the projection component and the intersection 85bc. One set of stroke data 80 is determined to correspond to a ruled line in the case where all of these distances determined for the one set of stroke data 80 are not more than the threshold. The ruled line extends along a direction perpendicular to the first axis 51.

For example, in the case where multiple intersections (the multiple intersections 85bc) are obtained for the first axis 51, the threshold for the distances recited above may be determined based on the local minimum value of the distances between the multiple intersections 85bc. For example, the threshold is not less than 0.05 times and not more than 0.2 times the local minimum value of the distances between the multiple intersections 85bc. For example, the threshold is 0.1 times the local minimum value of the distances between the multiple intersections 85bc.

Then, the stroke data of the multiple sets of stroke data 80 other than the stroke data determined to correspond to ruled lines is determined to correspond to non-ruled line data (i.e., cell data).

For example, in the case where the multiple sets of stroke data 80 include the first portion 81u, the second portion 82u, and the third portion 83u, the distance between the first portion 81u and the intersection recited above is shorter than the distance between the second portion 82u and the intersection and shorter than the distance between the third portion 83u and the intersection. The state of the distance being short includes the state in which the distance is zero.

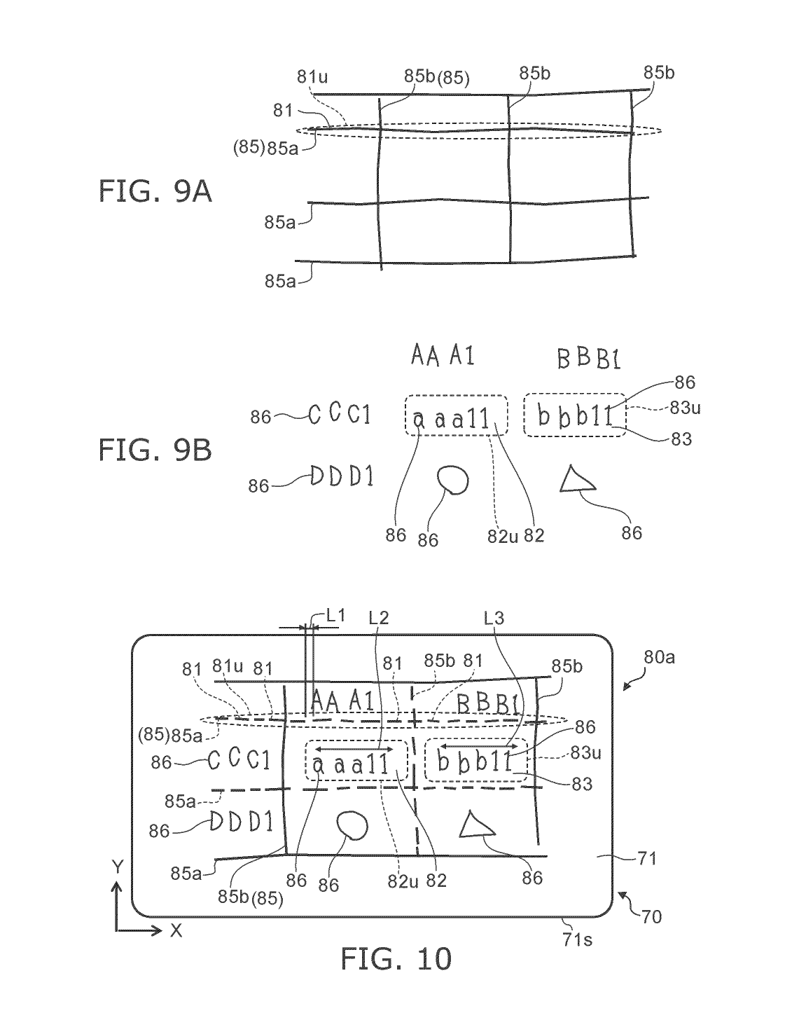

FIG. 9A and FIG. 9B are schematic views showing a portion of the operations of the handwritten document processing device according to the first embodiment.

FIG. 9A shows the stroke data (the ruled line input data 85) determined to correspond to ruled lines by the classification processing. FIG. 9B shows the stroke data (the non-ruled line input data 86) determined to correspond to non-ruled line data by the classification processing. The classification processing classifies the multiple sets of stroke data 80 acquired by the input/output unit 10 into the ruled line input data 85 and the non-ruled line input data 86.

Based on the ruled line input data 85 and the non-ruled line input data 86 that are classified, the ruled line output data 45 is provided at the position of the ruled line input data 85; and the non-ruled line output data 46 is provided at the position of the non-ruled line input data 86. In other words, the first table data 40a is obtained.

Such processing is performed by the processing unit 20; and the result (the first table data 40a) that is processed is supplied to the input/output unit 10. The display states shown in FIG. 3 and FIG. 4 are obtained by displaying the first table data 40a on the display unit 70. In other words, the first ruled line 41r that corresponds to the first portion 81u, the first cell data 41c that corresponds to the second portion 82u, the second cell data 42c that corresponds to the third portion 83u, and the second ruled line 42r that is provided between the first cell data 41c and the second cell data 42c are displayable.

FIG. 10 is a schematic view showing other stroke data of the handwritten document processing device according to the first embodiment.

In multiple sets of stroke data 80a of the example as shown in FIG. 10, a portion (the first portion 81u) of the ruled line input data 85 is a broken line (or a dotted line). In other words, for handwritten input, the ruled line is drawn as multiple line segments.

For example, the first portion 81u extends along the first direction. In the example, the first direction is the X-axis direction (e.g., the horizontal direction). The first portion 81u includes multiple sets of first stroke data 81. The multiple sets of first stroke data 81 are arranged along the first direction. The multiple sets of first stroke data 81 are separated from each other along the first direction. In other words, the first portion 81u is a broken line extending along the first direction.

In the example, each of the multiple sets of first stroke data 81 has a line configuration. In such a case, each of the multiple sets of first stroke data 81 may extend along the first direction.

For example, each of the multiple sets of first stroke data 81 may have a dot configuration. In such a case, the multiple sets of first stroke data 81 that have the dot configurations are arranged along the first direction. In the embodiment, the first portion 81u having such various configurations can be used.

In the example, the first portion 81u that has the broken line configuration extends along the first direction (the X-axis direction). In other words, the first portion 81u that has the broken line configuration is one of the horizontal ruled line input data 85a.

As shown in FIG. 10, at least one selected from the vertical ruled line input data 85b may have a broken line configuration. In the example, the spacing between the multiple sets of first stroke data 81 is relatively short. Thereby, the first portion 81u that includes the multiple sets of first stroke data 81 is recognized to be a ruled line having a broken line configuration. For example, spacing L1 between the multiple sets of first stroke data 81 is shorter than a length L2 of the second portion 82u along the first direction. The spacing L1 between the multiple sets of first stroke data 81 is shorter than a length L3 of the third portion 83u along the first direction.

Otherwise, the multiple sets of stroke data 80a shown in FIG. 10 are similar to the multiple sets of stroke data 80 described in regard to FIG. 2.

Even in the case where such multiple sets of stroke data 80a are acquired by the input/output unit 10, the processing unit 20 can derive the first table data 40a shown in FIG. 3 and FIG. 4.

In such a case, as shown in FIG. 3 and FIG. 4, the first ruled line 41r extends along the first direction in which the first portion 81u extends. In other words, the first ruled line 41r is substantially parallel to the first portion 81u having the broken line configuration.

An example of the processing of the processing unit 20 in the case where such multiple sets of stroke data 80a is used will now be described.

For example, in such a case as well, the processing unit 20 performs the first processing operation that includes the axis estimation processing (step S110), the intersection estimation processing (step S120), and the classification processing (step S130).

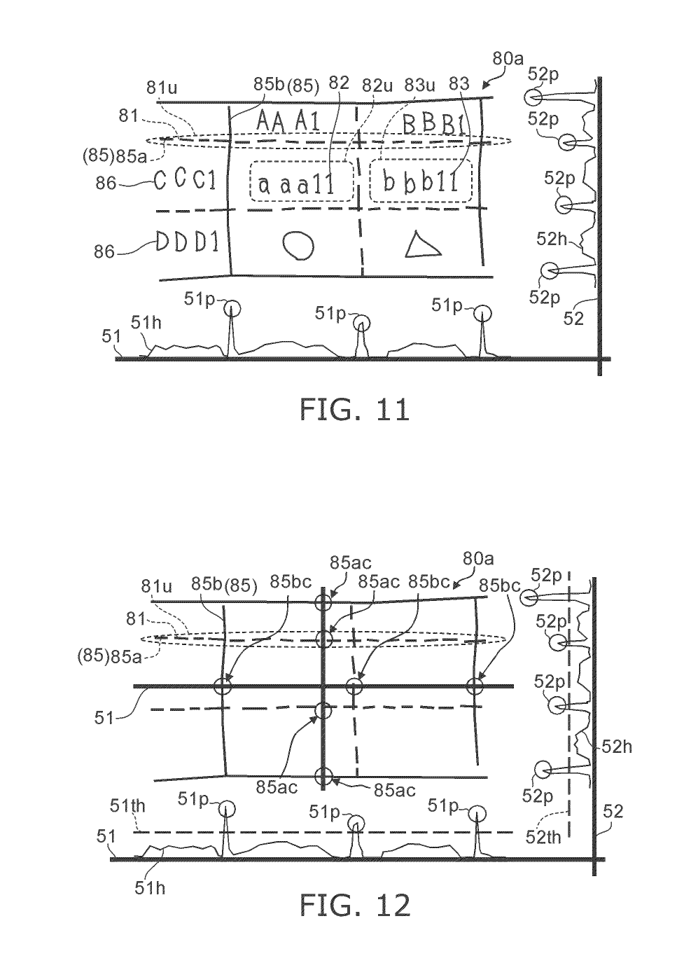

FIG. 11 is a schematic view showing a portion of the operations of the handwritten document processing device according to the first embodiment.

FIG. 11 shows the axis estimation processing. As shown in FIG. 11, the axis estimation processing estimates the first axis 51 and the second axis 52. The second axis 52 is perpendicular to the first axis 51.

In such a case as well, the stroke data (i.e., the ruled line input data 85, and in the example, the horizontal ruled line input data 85a) that corresponds to ruled lines has a component perpendicular to the second axis 52. The peaks 52p of the projection component occur on the second axis 52.

For example, the stroke data (i.e., the ruled line input data 85, and in the example, the vertical ruled line input data 85b) that corresponds to ruled lines has a component perpendicular to the first axis 51. The peaks 51p of the projection component occur on the first axis 51. The peaks 51p that correspond to the ruled line data of continuous stroke data are relatively high. The peaks 51p that correspond to the ruled line data of the stroke data having broken line configurations are relatively low.

In such a case as well, the cumulative projection component 51h and the cumulative projection component 52h of the projection components of the non-ruled line input data 86 are less than the values of the peaks 51p and the peaks 52p.

In such a case as well, the projection components are determined by rotating the axes that are candidates for the major axis and the minor axis in a range of 0 degrees to 180 degrees.

For example, in the case where the first stroke data 81 included in the first portion 81u extends in the horizontal direction, the heights of the peaks 52p of the cumulative projection component 52h of the projection component of the multiple sets of stroke data 80 onto the second axis 52 extending in the vertical direction are higher than the peak values of the cumulative projection component 52h of the projection component of the multiple sets of stroke data 80 onto a tilted axis (e.g., the second candidate axis 52o).

For example, the vertical ruled line input data 85b extends in the vertical direction. In such a case, the heights of the peaks 51p of the cumulative projection component 51h of the projection component of the multiple sets of stroke data 80 onto the first axis 51 extending in the horizontal direction are higher than the peak values of the cumulative projection component 51h of the projection component of the multiple sets of stroke data 80 onto a tilted axis (e.g., the first candidate axis 51o).

In such a case as well, the axis estimation processing may estimate the second axis 52 by, for example, minimizing the entropy of the cumulative projection component 52h of the projection component of the multiple sets of stroke data 80 onto the second axis 52.

FIG. 12 is a schematic view showing a portion of the operations of the handwritten document processing device according to the first embodiment.

FIG. 12 shows intersection estimation processing. In FIG. 12, the ruled line input data 85 of the stroke data 80 is shown, and the non-ruled line input data 86 of the stroke data 80 is not shown for easier viewing of the drawing.

As shown in FIG. 12, in such a case as well, the intersection estimation processing estimates, for example, the positions of the intersections 85bc between the first axis 51 and the vertical ruled line input data 85b and the positions of the intersections 85ac between the second axis 52 and the horizontal ruled line input data 85a.

In such a case as well, the first threshold 51th and the second threshold 52th are provided. As described above, the peak 51p that corresponds to the ruled line data of the stroke data having the broken line configuration is lower than the peaks 51p that correspond to the continuous ruled line data of the stroke data. By using the thresholds, it is easy to determine the intersections of the ruled line input data 85 having the broken line configuration.

For example, a set of coordinates is determined. For the set of coordinates, the value of the histogram continuously exceeds the threshold recited above. For example, for such a set of coordinates, the coordinates where the histogram has local maximums are the positions of intersections.

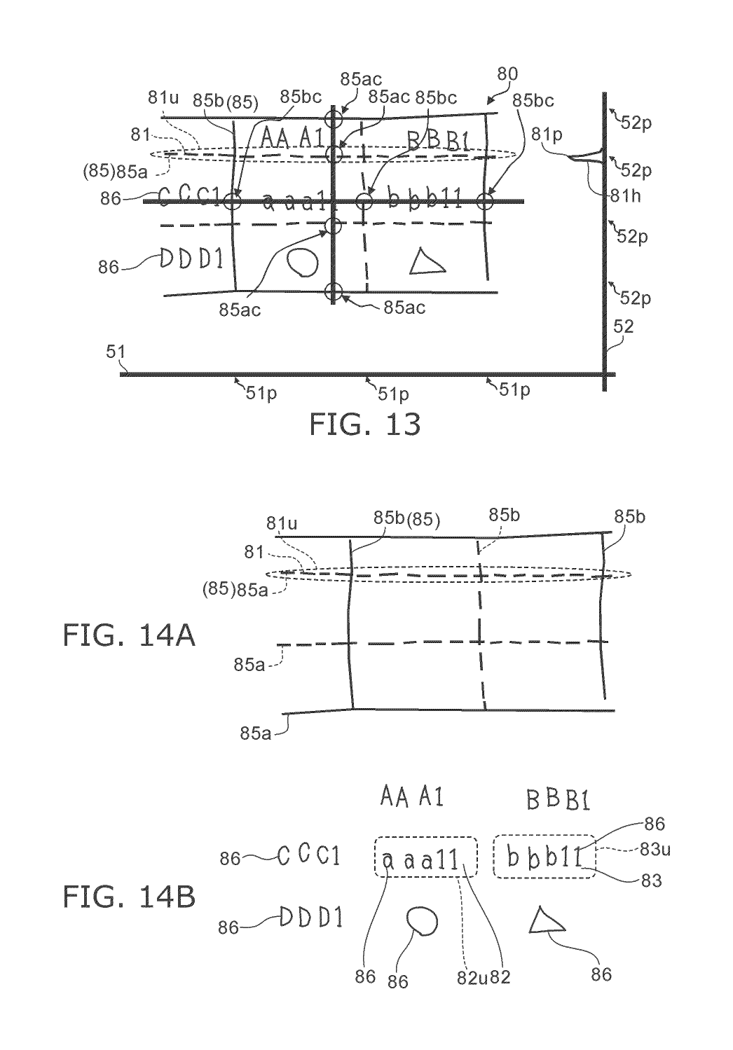

FIG. 13 is a schematic view showing a portion of the operations of the handwritten document processing device according to the first embodiment.

FIG. 13 shows classification processing. The classification processing classifies the multiple sets of stroke data 80 into the ruled line input data 85 and the non-ruled line input data 86.

For example, each of the stroke data 80 is projected onto the first axis 51 and the second axis 52. For example, the peak 81p occurs in the histogram (the cumulative projection component 81h) of the projection component of the first stroke data 81 onto the second axis 52.

In the case where the distance between the position on the second axis 52 of the peak 81p of the projected histogram and the position of the intersection 85ac on the second axis 52 is short, the stroke (the first stroke data 81) is determined to correspond to a ruled line. The ruled line extends along a direction perpendicular to the second axis 52. In such a case as well, for example, when the peak 81p is abrupt, the stroke (the first stroke data 81) is determined to correspond to a ruled line.

Then, the stroke data of the multiple sets of stroke data 80 other than the stroke data determined to correspond to ruled lines is determined to correspond to non-ruled line data (i.e., cell data).

FIG. 14A and FIG. 14B are schematic views showing a portion of the operations of the handwritten document processing device according to the first embodiment.

FIG. 14A shows the stroke data (the ruled line input data 85) determined to correspond to ruled lines by the classification processing. FIG. 14B shows the stroke data (the non-ruled line input data 86) determined to correspond to non-ruled line data by the classification processing. The classification processing classifies the multiple sets of stroke data 80 acquired by the input/output unit 10 into the ruled line input data 85 and the non-ruled line input data 86.

Even in the case where the first portion 81u of the ruled line input data 85 has a broken line configuration including the multiple sets of first stroke data 81, the first portion 81u is correctly determined to be a ruled line.

Based on the ruled line input data 85 and the non-ruled line input data 86 that are classified, the ruled line output data 45 is provided at the position of the ruled line input data 85; and the non-ruled line output data 46 is provided at the position of the non-ruled line input data 86. In other words, the first table data 40a is obtained.

Thus, according to the handwritten document processing device 110 according to the embodiment, the structure of the table is estimated based on the projection components of the stroke data onto the axes. Thereby, the table can be formatted even in the case where ruled lines having broken line configurations are input. A table that is more freely handwritten can be formatted. According to the embodiment, the formatting of the table can be implemented robustly.

For example, there is a reference example in which handwritten ruled line data is processed as image information. In the reference example, for example, the image information of the handwritten ruled line data is projected onto axes; and the ruled lines are estimated from the positions of the peaks of the histogram that is made. In such a case, errors occur easily in the case where the handwritten ruled line data has a broken line configuration. For example, the ruled line data is determined to be non-ruled line data. In other words, there are cases where the ruled line data having broken line configurations is erroneously determined to be shape information or character information of “-” (a bar). For example, it is difficult to prevent errors in the case where the handwritten table includes ruled line data having broken line configurations and cell data including “-.”

Conversely, in the embodiment, the handwritten document is processed based on the multiple sets of stroke data 80. Each of the stroke data 80 has information relating to the direction when handwriting. Such errors are suppressed by using a cumulative projection component of the stroke data 80 including the information relating to the direction projected onto the axes.

If the information relating to the direction is kept, it is possible to suppress the errors recited above by handling the case where continuous strokes are aligned in the same direction as in the ruled line data having broken line configurations.

In the handwritten document processing device 110 according to the embodiment, the ruled lines of a table of a handwritten document can be estimated even in the case where the ruled lines are omitted. According to the embodiment, a handwritten document processing device that can format a table that is more freely handwritten can be provided.

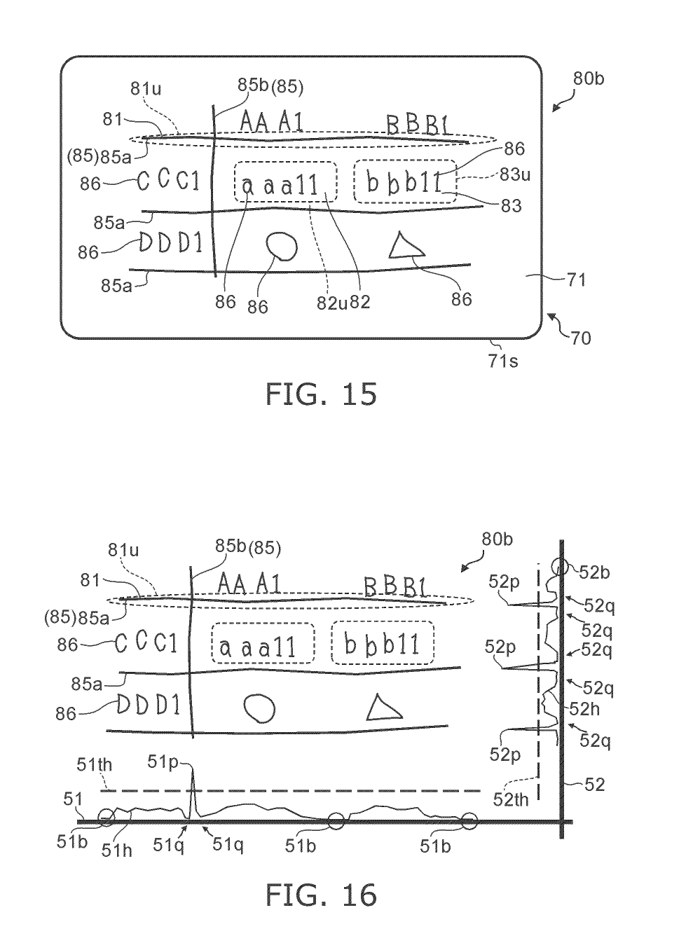

FIG. 15 is a schematic view showing other stroke data of the handwritten document processing device according to the first embodiment.

As shown in FIG. 15, stroke data corresponding to ruled lines is omitted from multiple sets of stroke data 80b of the example. For example, the uppermost horizontal ruled line of the stroke data 80 shown in FIG. 2 is omitted from the stroke data 80b shown in FIG. 15. Further, two vertical ruled lines of the stroke data 80 shown in FIG. 2 are omitted from the stroke data 80b shown in FIG. 15.

For example, the second portion 82u and the third portion 83u are adjacent to each other in the direction from the second portion 82u toward the third portion 83u. The multiple sets of stroke data 80 do not include the stroke data disposed between the second portion 82u and the third portion 83u.

In such a case as well, for example, the processing unit 20 performs the first processing operation that includes the axis estimation processing (step S110), the intersection estimation processing (step S120), and the classification processing (step S130).

FIG. 16 is a schematic view showing a portion of the operations of the handwritten document processing device according to the first embodiment.

FIG. 16 shows the axis estimation processing. As shown in FIG. 16, the axis estimation processing estimates the first axis 51 and the second axis 52. The second axis 52 is perpendicular to the first axis 51.

In such a case as well, the peaks 52p of the projection component occur on the second axis 52. Further, the peak 51p of the projection component occurs on the first axis 51. The cumulative projection component 51h and the cumulative projection component 52h of the projection components of the non-ruled line input data 86 are less than the values of the peaks 51p and the peak 52p.

In such a case, for example, the first stroke data 81 that is included in the first portion 81u extends in a prescribed direction (in the example, the horizontal direction). In such a case, the peak values (the heights of the peaks 52p) of the cumulative projection component 52h of the projection component of the multiple sets of stroke data 80 onto the second axis 52 extending in the vertical direction are higher than the peak values of the cumulative projection component 52h of the projection component of the multiple sets of stroke data 80 onto a tilted axis (e.g., the second candidate axis 52o) tilted with respect to the second axis 52.

For example, the vertical ruled line input data 85b extends in the vertical direction. In such a case, the peak values (the heights of the peaks 51p) of the cumulative projection component 51h of the projection component of the multiple sets of stroke data 80 onto the first axis 51 extending in the horizontal direction are higher than the peak values of the cumulative projection component 51h of the projection component of the multiple sets of stroke data 80 onto a tilted axis (e.g., the first candidate axis 51o) tilted with respect to the first axis 51.

As shown in FIG. 16, a bottom 52b (a local minimum portion) occurs in the cumulative projection component 52h of the projection component of the multiple sets of stroke data 80 onto the second axis 52 extending in the vertical direction at a position where the non-ruled line input data 86 does not exist (is omitted).

As described below, bottoms 51b (local minimum portions) and the bottom 52b (the local minimum portion) are estimated to correspond to the ruled lines that are omitted.

For example, in the cumulative projection component 52h of the projection component onto the second axis 52, the abrupt peaks 52p that correspond to the horizontal ruled line input data 85a occur; and the low and broad hills that correspond to the non-ruled line input data 86 occur. The heights of the abrupt peaks 52p are not less than the predetermined threshold 52th. Also, in the example, a low portion 52q occurs in the cumulative projection component 52h of the projection component between the abrupt peak 52p corresponding to the horizontal ruled line input data 85a and the low and broad hill corresponding to the non-ruled line input data 86. The portion 52q does not correspond to the ruled line data estimated to be omitted.

For example, for the second axis 52, at least one broad hill that corresponds to non-ruled line data is disposed between the bottom 52b estimated to be an omitted ruled line and the peak 52p corresponding to the ruled line data. Or, according to the omission state of the ruled lines, a broad hill of the cumulative projection component 52h of the projection component of the non-ruled line input data 86 may be disposed between two bottoms 52b (local minimum portions) estimated to be omitted ruled lines.

Similarly, the bottoms 51b (the local minimum portions) occur in the cumulative projection component 51h of the projection component of the multiple sets of stroke data 80 onto the first axis 51 extending in the horizontal direction at the positions where the non-ruled line input data 86 does not exist (is omitted).

For example, in the cumulative projection component 51h of the projection component onto the first axis 51, the abrupt peak 51p that corresponds to the vertical ruled line input data 85b occurs; and the low and broad hills that correspond to the non-ruled line input data 86 occur. The height of the abrupt peak 51p is not less than the predetermined threshold 51th. Also, in the example, a low portion 51q occurs in the cumulative projection component 52h of the projection component between the abrupt peak 51p corresponding to the vertical ruled line input data 85b and the low and broad hill corresponding to the non-ruled line input data 86. The portion 51q does not correspond to the ruled line data estimated to be omitted.

For example, for the first axis 51, at least one broad hill corresponding to non-ruled line data is disposed between the bottom 51b estimated to be an omitted ruled line and the peak 51p corresponding to the ruled line data. Or, a broad hill of the cumulative projection component 52h of the projection component of the non-ruled line input data 86 may be disposed between two bottoms 51b (local minimum portions) estimated to be omitted ruled lines.

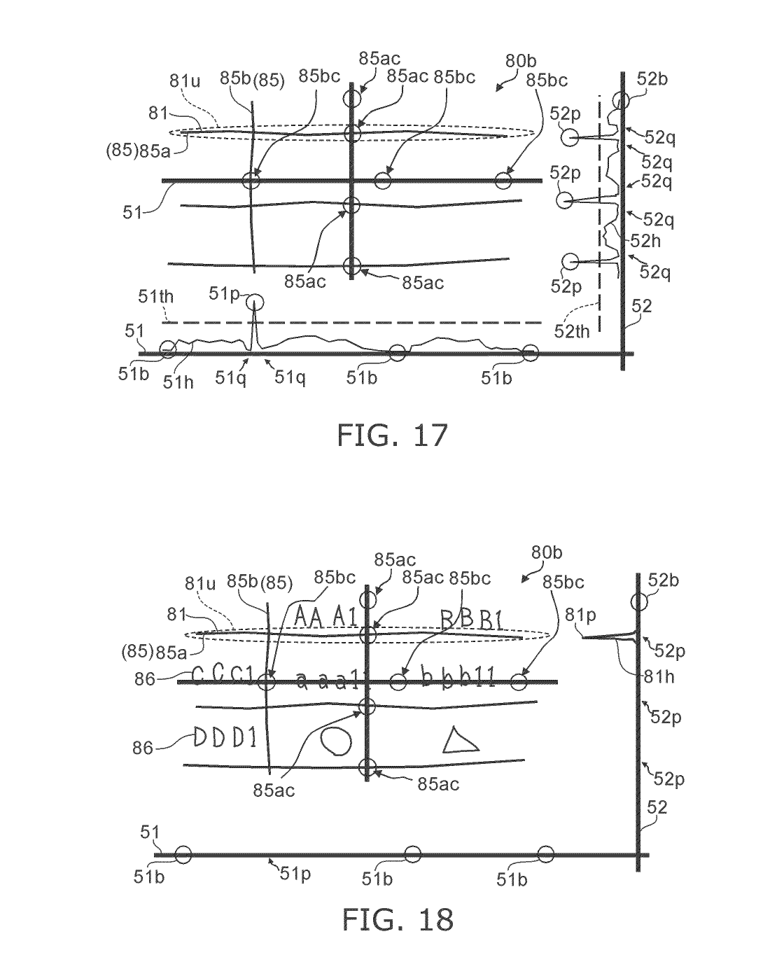

FIG. 17 is a schematic view showing a portion of the operations of the handwritten document processing device according to the first embodiment.

FIG. 17 shows the intersection estimation processing. In FIG. 17, the ruled line input data 85 of the stroke data 80 is shown, and the non-ruled line input data 86 of the stroke data 80 is not shown for easier viewing of the drawing.

As shown in FIG. 17, in such a case as well, the intersection estimation processing estimates, for example, the positions of the intersections 85bc between the first axis 51 and the vertical ruled line input data 85b and the positions of the intersections 85ac between the second axis 52 and the horizontal ruled line input data 85a.

For example, intersections are determined by a method described above for the ruled lines not omitted from the handwritten input. In other words, the intersection estimation processing estimates the intersection (at least one selected from the intersection 85ac and the intersection 85bc) based on at least one selected from the position of the peak 51p of the cumulative projection component 51h of the projection component of the multiple sets of stroke data 80 onto the first axis 51 and the position of the peak 52p of the cumulative projection component 52h of the projection component of the multiple sets of stroke data 80 onto the second axis 52.

On the other hand, intersections are determined based on the positions of the bottoms of the projection component for the ruled lines estimated to be omitted from the handwritten input. For example, the intersection estimation processing estimates the intersection (at least one selected from the intersection 85ac and the intersection 85bc) based on at least one selected from the position of the bottom 51b of the cumulative projection component 51h of the projection component of the multiple sets of stroke data 80 onto the first axis 51 and the position of the bottom 52b of the cumulative projection component 52h of the projection component of the multiple sets of stroke data 80 onto the second axis 52.

Thus, in the example, the intersection estimation processing includes estimating at least one intersection based on at least one selected from the position of the bottom 51b of the cumulative projection component 51h of the projection component of the multiple sets of stroke data 80 onto the first axis 51 and the position of the bottom 52b of the cumulative projection component 52h of the projection component of the multiple sets of stroke data 80 onto the second axis 52.

FIG. 18 is a schematic view showing a portion of the operations of the handwritten document processing device according to the first embodiment.

FIG. 18 shows the classification processing. For example, each of the stroke data 80 is projected onto the first axis 51 and the second axis 52. FIG. 18 shows the histogram (the cumulative projection component 81h) of the projection component of the first stroke data 81 onto the second axis 52 as an example. The peak 81p occurs in the histogram (the cumulative projection component 81h).

At the second axis 52, the position of the peak 52p of the cumulative projection component 52h is estimated to be the position of at least one of the intersections 85ac. For example, the stroke (the first stroke data 81) is determined to correspond to a ruled line in the case where the distance between the position of the peak 81p of the projected histogram on the second axis 52 and the position of the intersection 85ac on the second axis 52 is short.

Further, at the second axis 52, the position of the bottom 52b of the cumulative projection component 52h is estimated to be the position of another intersection 85ac.

The ruled line that corresponds to the peak 52p is a ruled line input by handwriting. The ruled line that corresponds to the bottom 52b is a ruled line estimated to be omitted from the handwritten input. These ruled lines extend along a direction perpendicular to the second axis 52.

Similarly, at the first axis 51, the position of the peak 51p of the cumulative projection component 51h is estimated to be the position of at least one of the intersections 85bc. Further, at the first axis 51, the position of the bottom 51b of the cumulative projection component 51h is estimated to be the position of another intersection 85bc.

The ruled line that corresponds to the peak 51p is a ruled line input by handwriting. The ruled line that corresponds to the bottom 51b is a ruled line estimated to be omitted from the handwritten input. These ruled lines extend along a direction perpendicular to the first axis 51.

Then, the stroke data of the multiple sets of stroke data 80 other than the stroke data determined to correspond to ruled lines is determined to correspond to non-ruled line data (i.e., cell data).

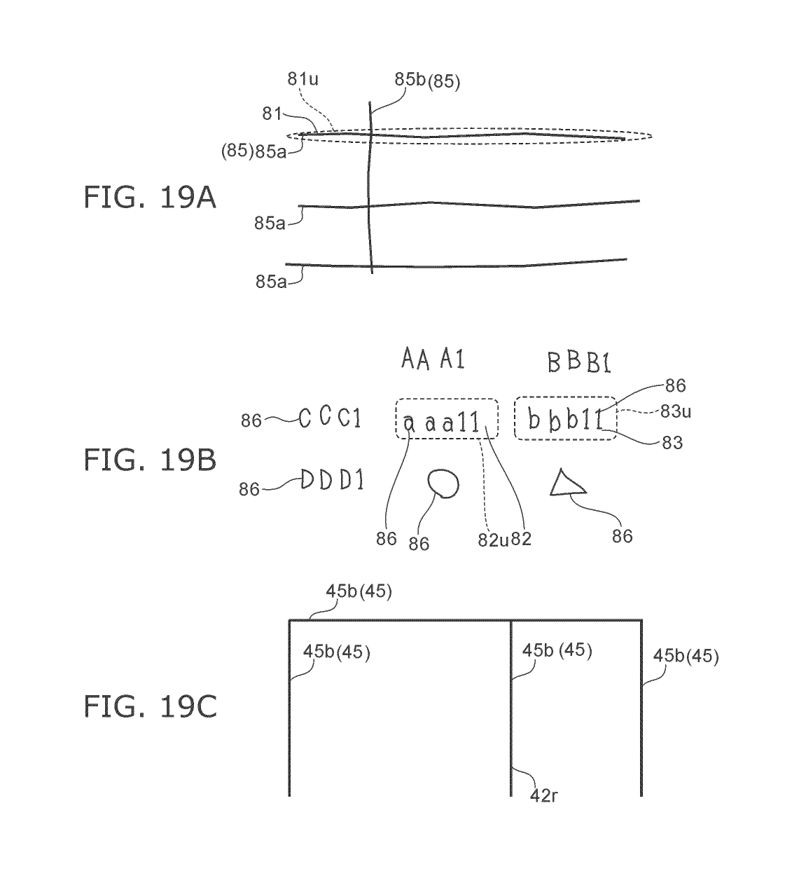

FIG. 19A to FIG. 19C are schematic views showing a portion of the operations of the handwritten document processing device according to the first embodiment.

FIG. 19A shows the stroke data (the ruled line input data 85) determined to correspond to ruled lines by the classification processing. FIG. 19B shows the stroke data (the non-ruled line input data 86) determined to correspond to non-ruled line data by the classification processing. FIG. 19C shows the ruled line output data 45 (the horizontal ruled line output data 45a and the vertical ruled line output data 45b) that is made based on at least one selected from the bottom 51b and the bottom 52b.

The classification processing classifies the multiple sets of stroke data 80 acquired by the input/output unit 10 into the ruled line input data 85 and the non-ruled line input data 86.

Further, in addition to the stroke data (the ruled line input data 85) determined to correspond to ruled lines, at least a portion of the horizontal ruled line output data 45a and the vertical ruled line output data 45b is made to correspond to the ruled lines estimated to be omitted.

In the example shown in FIG. 19C, the ruled line output data 45 that is made includes the second ruled line 42r. Thereby, the ruled line output data 45 that is made and the ruled line output data 45 that is based on the ruled line input data 85 are obtained by the processing unit 20. In other words, the first table data 40a that is shown in FIG. 3 or FIG. 4 is obtained.

For example, the ruled line (in the example, the second ruled line 42r) is made based on at least one selected from the bottom 51b and the bottom 52b. For example, in the case where the second ruled line 42r is made based on the bottom 51b, the second ruled line 42r includes the position of the bottom 51b and is aligned with the second axis 52. In other words, in such a case, the second ruled line 42r is perpendicular to the first axis 51. For example, in the case where the second ruled line 42r is made based on the bottom 52b, the second ruled line 42r includes the position of the bottom 52b and is aligned with the first axis 51. In other words, in such a case, the second ruled line 42r is perpendicular to the second axis 52.

In the example, strokes that correspond to ruled lines are omitted. Therefore, peaks corresponding to the ruled lines that are omitted do not occur. Therefore, the intersections are estimated by estimating that there is a ruled line between the cell data which is non-ruled line data.

Thus, according to the handwritten document processing device 110 according to the embodiment, the structure of the table is estimated based on the projection component of the stroke data onto the axis. Thereby, the table can be formatted even in the case where there is a ruled line estimated to be omitted. A table that is more freely handwritten can be formatted. According to the embodiment, the formatting of the table can be implemented robustly.

In the embodiment, at least a portion of the intersection estimation processing may be implemented simultaneously with at least a portion of the classification processing. At least a portion of the intersection estimation processing may be omitted.

For example, the first processing operation includes the classification processing and the axis estimation processing recited above. The classification processing classifies the multiple sets of stroke data 80 into ruled line data and cell data that is different from the ruled line data based on at least one selected from the cumulative projection component 51h of the projection component of the multiple sets of stroke data 80 onto the first axis 51 and the cumulative projection component 52h of the projection component of the multiple sets of stroke data 80 onto the second axis 52. The first ruled line 41r recited above includes at least a portion of the ruled line data recited above. In such a case, for example, the peak 52p of the cumulative projection component 52h of the projection component of the ruled line data onto the second axis 52 recited above is higher than the peak of the cumulative projection component 52h of the projection component of the cell data onto the second axis 52. For example, the peak 51p of the cumulative projection component 51h of the projection component of the ruled line data onto the first axis 51 recited above is higher than the peak of the cumulative projection component 51h of the projection component of the cell data onto the first axis 51.

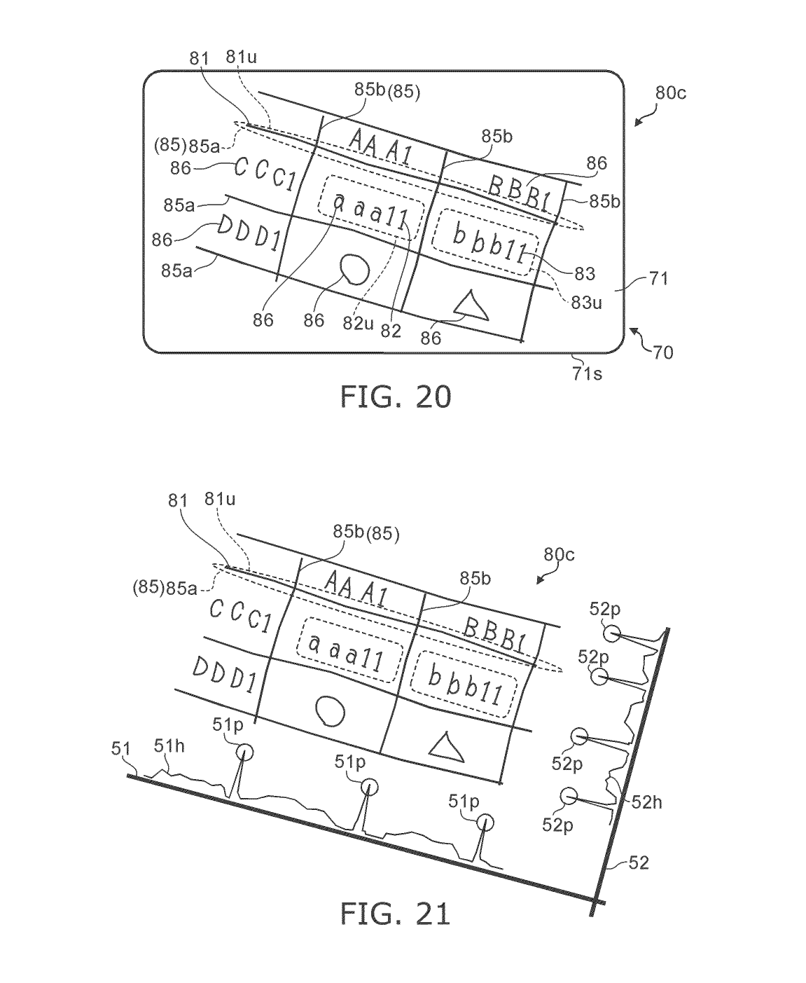

FIG. 20 is a schematic view showing other stroke data of the handwritten document processing device according to the first embodiment.

In the example as shown in FIG. 20, the table according to multiple sets of stroke data 80c is input as being tilted. For example, such a tilted table is handwritten when the input device such as a tablet for handwritten input, etc., is tilted.

For example, the extension direction of the first portion 81u of the multiple sets of stroke data 80c is tilted with respect to the side 71s of the display region 71 of the display unit 70.

At this time as well, the first processing operation described above is implemented.

FIG. 21 is a schematic view showing a portion of the operations of the handwritten document processing device according to the first embodiment.

The drawing shows the axis estimation processing.

As shown in FIG. 21, in such a case as well, the axis estimation processing estimates the first axis 51 and the second axis 52. The first axis 51 is aligned with the extension direction of the first portion 81u. Therefore, the first axis 51 is tilted.

In such a case as well, the stroke data (e.g., the horizontal ruled line input data 85a) that corresponds to ruled lines has a component perpendicular to the second axis 52. The peak 52p of the projection component occurs at a designated coordinate on the second axis 52 when the perpendicular component is projected onto the second axis 52.

For example, the stroke data (e.g., the vertical ruled line input data 85b) that corresponds to ruled lines has a component perpendicular to the first axis 51. The peak 51p of the projection component occurs at a designated coordinate on the first axis 51 when the perpendicular component is projected onto the first axis 51.

In such a case as well, for example, the axis estimation processing determines the projection component by rotating the axis that is a candidate for the major axis in a range of 0 degrees to 180 degrees. In other words, the first candidate axis 51o and the second candidate axis 52o that extend in prescribed directions are set; and the heights of the peaks at this time are calculated. Then, the angles of the directions in which the candidate axes extend are changed; and the heights of the peaks at each angle are determined. Then, the candidate axes at the angles where the heights of the peaks are high are used as the first axis 51 and the second axis 52. Thus, the first axis 51 and the second axis 52 are determined.

Further, the first table data 40a is derived by implementing, for example, the intersection estimation processing and the classification processing.

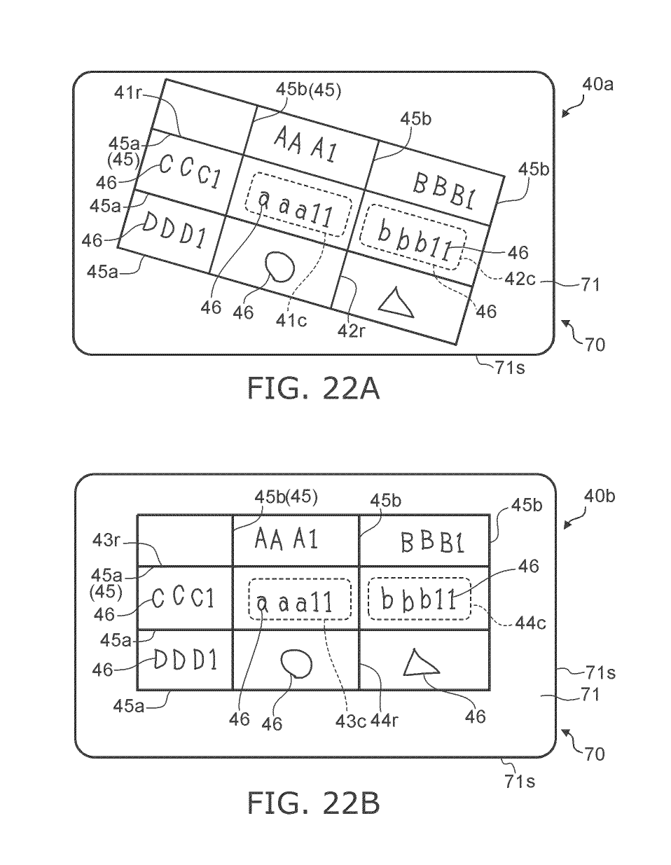

FIG. 22A and FIG. 22B are schematic views showing processing results of the handwritten document processing device according to the first embodiment.

FIG. 22A shows the first table data 40a. FIG. 22B shows second table data 40b.

As shown in FIG. 22A, the first table data 40a that includes the first ruled line 41r corresponding to the first portion 81u, the first cell data 41c corresponding to the second portion 82u, the second cell data 42c corresponding to the third portion 83u, and the second ruled line 42r is derived. Such first table data 40a is supplied to the input/output unit 10 and is displayable by the display unit 70. In such a case as well, the second ruled line 42r is provided between the first cell data 41c and the second cell data 42c.

In the example, because the table that is input by handwriting is tilted with respect to the side 71s of the display region 71 of the display unit 70, the ruled lines (the first ruled line 41r, the second ruled line 42r, etc.) of the first table data 40a are tilted with respect to the side 71s.

In such a case, the processing unit 20 may derive the second table data 40b.

In the second table data 40b as shown in FIG. 22B, the ruled lines (the first ruled line 41r, the second ruled line 42r, etc.) of the first table data 40a are parallel or perpendicular to the side 71s. Such second table data 40b is obtained by, for example, rotating the first table data 40a. The angle of the rotation is determined based on, for example, the angle between the side 71s of the display region 71 and the extension direction of the first portion 81u of the multiple sets of stroke data 80c that is input by handwriting. For example, the first ruled line 41r, the second ruled line 42r, etc., are rotated this angle. The cell data (e.g., the first cell data 41c, the second cell data 42c, etc.) also may be rotated.

For example, a third ruled line 43r that is shown in FIG. 22B is made by rotating the first ruled line 41r shown in FIG. 22A. A fourth ruled line 44r that is shown in FIG. 22B is made by rotating the second ruled line 42r shown in FIG. 22A. Third cell data 43c that is shown in FIG. 22B is made by rotating the first cell data 41c shown in FIG. 22A. Fourth cell data 44c that is shown in FIG. 22B is made by rotating the second cell data 42c shown in FIG. 22A.

Such processing can be implemented by the processing unit 20. In other words, the processing unit 20 can perform the following second processing operation. The second processing operation derives the second table data 40b based on the multiple sets of stroke data 80c acquired by the input/output unit 10, where the second table data 40b includes the third ruled line 43r corresponding to the first portion 81u and the third cell data 43c corresponding to the second portion 82u. In the example, the second table data 40b further includes the fourth cell data 44c corresponding to the third portion 83u and the fourth ruled line 44r. The fourth ruled line 44r passes between the third cell data 43c and the fourth cell data 44c. The fourth ruled line 44r is perpendicular or parallel to the third ruled line 43r.

Such second table data 40b is supplied to the input/output unit 10. The second table data 40b is supplied from the input/output unit 10 to the display unit 70; and the second table data 40b is displayed by the display unit 70.

The extension direction of the first portion 81u when the first portion 81u is displayed by the display unit 70 intersects the extension direction of the third ruled line 43r when the third ruled line 43r is displayed by the display unit 70. In other words, the extension directions are non-parallel. For example, the extension direction of the first portion 81u is tilted with respect to the side 71s of the display region 71 of the display unit 70. The extension direction of the third ruled line 43r is aligned with the side 71s. Or, the extension direction of the third ruled line 43r is perpendicular to the side 71s. As the side 71s, a side of the display region 71 in the vertical direction may be used; or a side of the display region 71 in the horizontal direction may be used.

Thus, the handwritten document processing device 110 according to the embodiment is applicable in the case where the handwritten table is tilted. Even in the case where the ruled lines are drawn to be obliquely tilted, the directions of the axes of the table can be estimated correctly. According to the embodiment, the structure of the table can be estimated robustly for rotations.

The embodiment is applicable in the case where, for example, a tilted table is drawn on the input screen of a notebook-sized application using a pen input interface. The embodiment is applicable in the case where, for example, multiple users are drawing, and persons that are positioned obliquely to the screen draw the table. In such cases, the ruled lines and other data (cell data) of the table can be classified according to the intensions of the users. The table is formatted easily based on the result.

The handwritten document processing device 110 according to the embodiment is applicable to, for example, an application including a pen input interface (or an input interface by finger). In the application, the user can input the table by handwriting by, for example, freely making a layout without utilizing shape drawing tools, etc.

In such a case, the ruled lines may be drawn to be tilted with respect to the input plane. Further, one ruled line may be drawn discontinuously. Also, when inputting the table by handwriting, ruled lines may be omitted from the input.

According to the embodiment, for example, such conditions can be handled. The user interface can be improved. For example, the formatting of the table can be performed by appropriately processing the handwritten ruled lines.

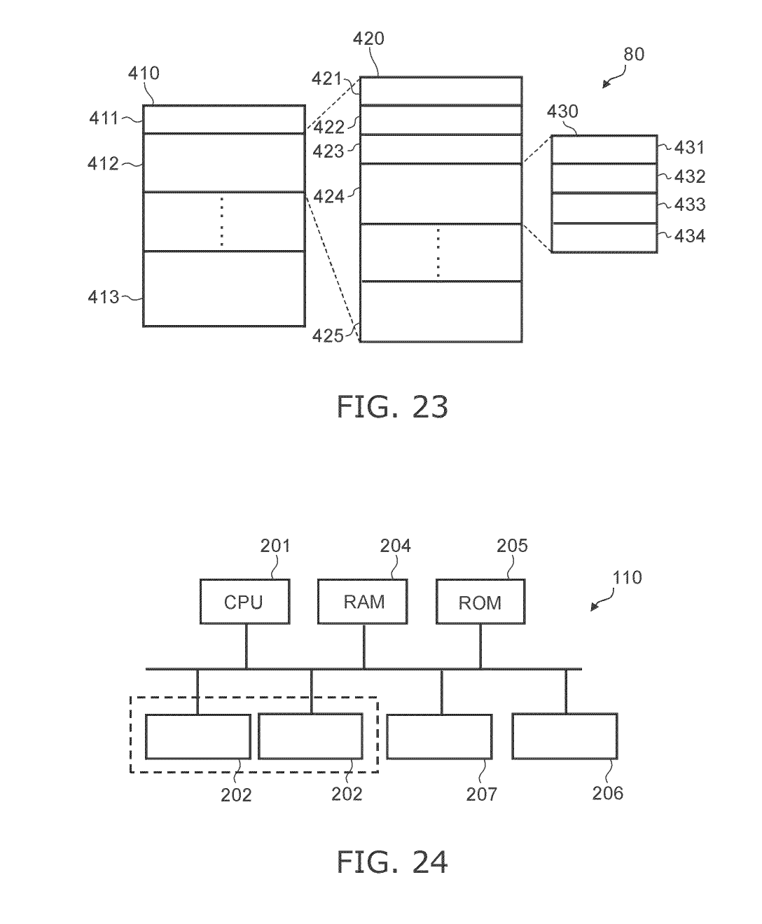

FIG. 23 is a schematic view showing data used in the handwritten document processing device according to the first embodiment.

FIG. 23 shows an example of the data structure of the multiple sets of stroke data 80. The stroke data 80 is, for example, handwritten data.

For example, an ink data structure 410 includes a total stroke count 411 and multiple stroke structures (a stroke structure 412, a stroke structure 413, etc.).

“Stroke” corresponds to a stroke that is input by handwriting. The stroke corresponds to, for example, the path of a pen or the like from when the pen or the like contacts the input plane to when the pen or the like leaves the input plane. For example, points on the path are sampled at a prescribed timing (e.g., a constant period). The stroke is expressed by, for example, the time series of the points that are sampled.

A stroke structure 420 of one stroke is, for example, one selected from the stroke structure 412, the stroke structure 413, etc. The stroke structure 420 is expressed by, for example, the set (the point structures) of the values of the coordinates on the plane where the pen has moved.

For example, the stroke structure 420 includes a total point count 421, a start time 422, a circumscribing shape 423, and point structures (a point structure 424, a point structure 425, etc.). The total point count 421 is the number of points that form the stroke. The number of point structures is the total point count 421.

The start time 422 is, for example, the time at which the stroke is drawn by the pen contacting the input plane. The circumscribing shape 423 is the circumscribing shape of the path of the stroke on the document plane. It is favorable for the circumscribing shape 423 to be, for example, a rectangle of the local minimum surface area that contains the stroke on the document plane.

The point structures (the point structure 424, the point structure 425, etc.) depend on, for example, the input device. A point structure 430 which is one point structure includes, for example, an x-coordinate 431, a y-coordinate 432, writing pressure 433, and a time difference 434. The x-coordinate 431 is the coordinate in the x-direction of the sampled point. The y-coordinate 432 is the coordinate in the y-direction of the sampled point. The writing pressure 433 is the writing pressure of the sampled point. The time difference 434 is, for example, the time difference between the initial time (e.g., the start time 422 recited above) and the time of the sampling of the point. The point structure 430 includes four such values.

For example, the coordinates are a coordinate system in the document plane. For example, the upper left corner of the document plane is used as the origin of the coordinates. For example, the values of the coordinates increase from the origin toward the lower right corner. The coordinates may be expressed by such positive values.

For example, there are cases where the input device does not acquire the writing pressure, or the data of the writing pressure is not used in subsequent processing even when acquired. In such a case, the writing pressure 433 is omissible. Or, data that indicates that the writing pressure 433 is invalid may be added to the writing pressure 433.

In the stroke structure 420, the actual data of the x-coordinate 431, the y-coordinate 432, etc., may be written to the region of each of the point structures 430. Or, in the stroke structure 420, link information to the corresponding point structure 430 may be written to the region of each of the point structures 430. For example, this is applicable in the case where the data of the stroke structure 420 and the data of the point structure 430 are managed separately.

The handwritten document processing device 110 according to the embodiment is, for example, a stand-alone device. For example, the configuration of the handwritten document processing device 110 may be dispersed over multiple nodes. The multiple nodes can communicate with each other via, for example, a network.

The handwritten document processing device 110 includes, for example, a desktop computer, a laptop computer, a portable computer, etc. The handwritten document processing device 110 includes a portable information device, an information device including a touch panel, a smartphone, etc. The document processing device 110 includes various information processing devices. The handwritten document processing device 110 includes various devices.

FIG. 24 is a schematic view showing the handwritten document processing device according to the first embodiment.

FIG. 24 is a block diagram of the handwritten document processing device 110. FIG. 24 shows an example of hardware of the handwritten document processing device 110.

The handwritten document processing device 110 includes, for example, a CPU 201, an input device 202, an output device 203, a RAM 204, a ROM 205, an external memory interface 206, and a communication interface 207. For example, at least one selected from the input device 202, the output device 203, the external memory interface 206, and the communication interface 207 is used as the input/output unit 10. For example, the CPU 201 is used as the processing unit 20.

In the case where a touch panel is used as the handwritten document processing device 110, for example, a liquid crystal panel, a pen, a stroke sensor provided on the liquid crystal panel, etc., are utilized.

For example, a portion of the handwritten document processing device 110 may be provided in a client; and another portion of the handwritten document processing device 110 may be provided in a server.

FIG. 25 is a schematic view showing the handwritten document processing device according to the first embodiment.

As shown in FIG. 25, a server 303 is provided on a network 300. The network 300 includes, for example, at least one selected from an intranet and the Internet. A client 301 and a client 302 can communicate with the server 303 via the network 300. The handwritten document processing device 110 according to the embodiment may be formed of such a client and server.

For example, the client 301 is connected to the network 300 via wireless communication. The client 302 is connected to the network 300 via wired communication.

The client 301 and the client 302 are, for example, user devices. The server 303 is provided, for example, on a LAN. For example, an intra-corporate LAN, etc., is used as the LAN. The server 303 may be managed by, for example, an Internet service provider, etc. The server 303 may be a user device. The user may provide the functions of the server to other users. Various modifications of the configuration of the handwritten document processing device 110 being dispersed in clients and servers are possible.

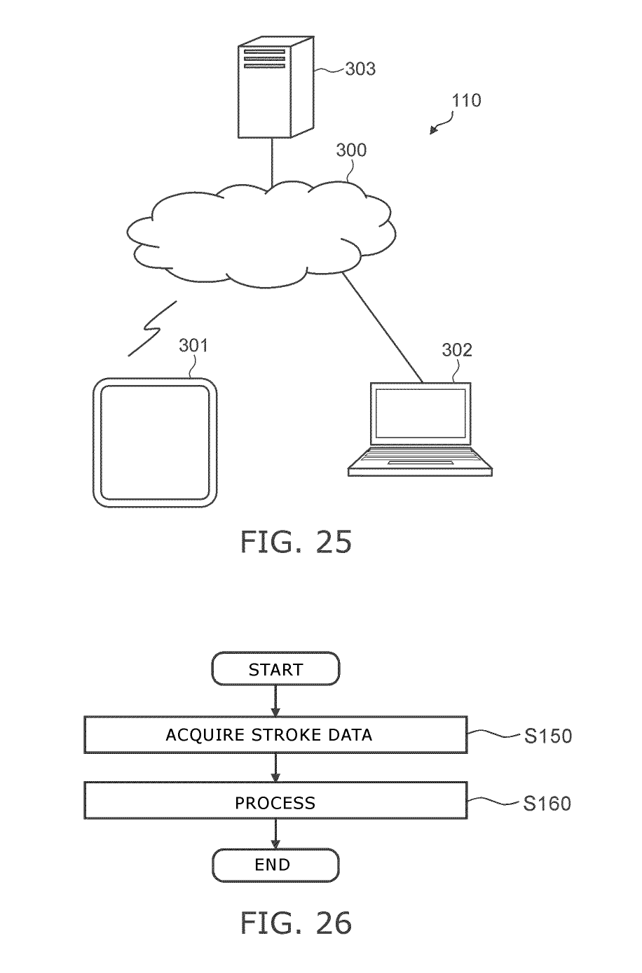

FIG. 26 is a flowchart showing the operations of the handwritten document processing device according to the first embodiment.

In the document processing device 110 as shown in FIG. 26, for example, the multiple sets of stroke data 80 of a handwritten document are acquired (step S150). The operation is implemented by, for example, the input/output unit 10. The multiple sets of stroke data 80 include, for example, the first portion 81u including the first stroke data 81, the second portion 82u including the second stroke data 82, and the third portion 83u including the third stroke data 83.

Then, processing (e.g., the first processing operation) is implemented (step S160). The processing is implemented by, for example, the processing unit 20. The first processing operation derives the first table data 40a based on the multiple sets of stroke data 80 that is acquired, where the first table data 40a includes the first ruled line 41r corresponding to the first portion 81u, the first cell data 41c corresponding to the second portion 82u, the second cell data 42c corresponding to the third portion 83u, and the second ruled line 42r provided between the first cell data 41c and the second cell data 42c. Then, the first table data 40a is output.

### Second Embodiment

The embodiment relates to a handwritten document processing program. The processing described in the first embodiment is implementable based on a program which is software.

The program implements at least a portion of the processing described in the first embodiment.

For example, the handwritten document processing program causes a computer to acquire the multiple sets of stroke data 80 of the handwritten document. The multiple sets of stroke data 80 include the first portion 81u including the first stroke data 81, the second portion 82u including the second stroke data 82, and the third portion 83u including the third stroke data 83.

The handwritten document processing program causes the computer to implement the first processing operation. The first processing operation derives the first table data 40a based on the multiple sets of stroke data 80 that is acquired, where the first table data 40a includes the first ruled line 41r corresponding to the first portion 81u, the first cell data 41c corresponding to the second portion 82u, the second cell data 42c corresponding to the third portion 83u, and the second ruled line 42r provided between the first cell data 41c and the second cell data 42c.

Further, the handwritten document processing program may cause the computer to implement the second processing operation recited above.

The handwritten document processing program according to the embodiment is storable in, for example, a versatile computer system. Effects similar to the effects obtained by the handwritten document processing device 110 according to the embodiment can be obtained by reading the program.

The instructions described in the embodiment are recordable in a recording medium as a program that can be executed by the computer. For example, a magnetic disk (a flexible disk, a hard disk, etc.), an optical disk (CD-ROM, CD-R, CD-RW, DVD-ROM, DVD±R, DVD±RW, etc.), a semiconductor memory, etc., may be used as the recording medium.

The recording medium is readable by a computer or an embedded system. The format of the recording (the storage) of the recording medium is arbitrary.

The computer reads the program from the recording medium and causes the CPU to execute the instructions described in the program based on the program. The operations of the handwritten document processing device 110 according to the embodiment can be implemented. The computer may acquire or read the program via a network when acquiring or reading the program.

The program is installed from the recording medium into, for example, the computer and/or the embedded system. Based on the instructions of the program, the OS (operating system) operating on the computer, database management software, MW (middleware) of the network, etc., may execute a portion of the processing included in the embodiment.

The recording medium according to the embodiment is, for example, independent of the computer or the embedded system. The embodiment is not limited thereto; and the recording medium according to the embodiment also includes, for example, a recording medium that stores or temporarily stores a downloaded program. The download of the program is performed via, for example, a LAN, the Internet, etc.

There may be one or multiple recording media in the embodiment. The processing according to the embodiment may be executed based on the multiple recording media. The configurations of the media included in the recording media according to the embodiment are arbitrary.

The computer or embedded system according to the embodiment executes the processing of the embodiment based on the program stored in the recording medium. The computer or embedded system according to the embodiment may include, for example, one device such as a personal computer, a microcomputer, etc. The computer or embedded system according to the embodiment may include, for example, a system in which multiple devices are connected in a network, etc.

The computer according to the embodiment also may include a personal computer, a processor included in an information processing device, a microcomputer, etc. The computer according to the embodiment includes devices that can realize the functions according to the embodiment by a program.

### Third Embodiment

The embodiment relates to a handwritten document processing method. In the method, for example, the processing described in regard to FIG. 26 is performed. In the handwritten document processing method, the handwritten document processing device 110 described in the first embodiment and modifications of the handwritten document processing device 110 can be used.

The embodiment can provide a handwritten document processing device, a handwritten document processing method, and a handwritten document processing program that can format a table that is more freely handwritten.

In the specification of the application, “orthogonal,” “perpendicular,” or “parallel” include fluctuation, etc., and include the state of being substantially perpendicular or substantially parallel.

Hereinabove, embodiments of the invention are described with reference to specific examples. However, the invention is not limited to these specific examples. For example, one skilled in the art may similarly practice the invention by appropriately selecting specific configurations of components included in the handwritten document processing device such as the input/output unit, the processing unit, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all handwritten document processing devices, handwritten document processing methods, and handwritten document processing programs practicable by an appropriate design modification by one skilled in the art based on the handwritten document processing devices, handwritten document processing methods, and handwritten document processing programs described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A handwritten document processing device, comprising:
an input/output controller configured to acquire stroke data of a handwritten document, the stroke data comprising a first portion, a second portion, and a third portion, the first portion comprising first stroke data, the second portion comprising second stroke data, the third portion comprising third stroke data; and
a processor configured to derive first table data based on the stroke data and supply the first table data to the input/output controller, the first table data comprising a first ruled line, first cell data, second cell data, and a second ruled line, the first ruled line corresponding to the first portion, the first cell data corresponding to the second portion, the second cell data corresponding to the third portion, the second ruled line provided between the first cell data and the second cell data.

2. The device according to claim 1, wherein
the first portion extends along a first direction,
the first portion comprises sets of the first stroke data,
the sets of first stroke data are separated from each other along the first direction, and
the first ruled line extends along the first direction.

3. The device according to claim 2, wherein a space between the sets of first stroke data is shorter than a length of the second portion along the first direction and shorter than a length of the third portion along the first direction.

4. The device according to claim 1, wherein the second portion and the third portion are adjacent to each other in a direction from the second portion toward the third portion.

5. The device according to claim 1, wherein
the processor is configured to derive second table data based on the stroke data acquired by the input/output controller and supply the second table data to the input/output controller, wherein the second table data comprises a third ruled line and third cell data, the third ruled line corresponding to the first portion, the third cell data corresponding to the second portion, and
an extension direction of the first portion when the first portion is displayed on a display intersects an extension direction of the third ruled line when the third ruled line is displayed on the display.

6. The device according to claim 5, wherein
the display comprises a display region having a side,
the extension direction of the first portion is tilted with respect to the side, and
the extension direction of the third ruled line is aligned with the side.

7. The device according to claim 1, wherein
the deriving first table data comprises:
axis estimation processing of deriving a first axis and a second axis, the second axis being perpendicular to the first axis, a peak value of a cumulative projection component of the stroke data onto the second axis higher than a peak value of a cumulative projection component of the stroke data onto an axis tilted with respect to the second axis; and
ruled line derivation processing of deriving the second ruled line passing between the second portion and the third portion parallel or perpendicular to the first ruled line, and deriving the first ruled line corresponding to the first portion based on the cumulative projection component of the stroke data onto the second axis, and
a peak value of a projection component of the first portion onto the second axis is higher than a peak value of a projection component of the second portion onto the second axis and higher than a peak value of a projection component of the third portion onto the second axis.

8. The device according to claim 1, wherein
the deriving the first table data comprises:
axis estimation processing of deriving a first axis and a second axis, the second axis perpendicular to the first axis, a peak value of a cumulative projection component of the sets of stroke data onto the second axis higher than a peak value of a cumulative projection component of the stroke data onto an axis tilted with respect to the second axis; and
classification processing of classifying the stroke data into ruled line data and cell data based on at least one selected from the cumulative projection component of the stroke data onto the first axis and the cumulative projection component of the stroke data onto the second axis, the cell data different from the ruled line data, and
the first ruled line comprises at least a portion of the ruled line data.

9. The device according to claim 8, wherein a peak value of a cumulative projection component of the ruled line data onto the second axis is higher than a peak value of a cumulative projection component of the cell data onto the second axis.

10. The device according to claim 1, wherein
the deriving the first table data comprises:
axis estimation processing of deriving a first axis and a second axis, the second axis being perpendicular to the first axis, a peak value of a cumulative projection component of the stroke data onto the second axis higher than a peak value of a cumulative projection component of the stroke data onto an axis tilted with respect to the second axis;
intersection estimation processing of estimating an intersection where the first ruled line intersects at least one selected from the first axis and the second axis based on at least one selected from a cumulative projection component of the stroke data onto the first axis and the cumulative projection component of the stroke data onto the second axis; and
classification processing of classifying the stroke data into ruled line data and cell data based on distances between the estimated intersection and the stroke data, the cell data being different from the ruled line data, and
a distance between the first portion and the intersection is shorter than a distance between the second portion and the intersection and shorter than a distance between the third portion and the intersection.

11. The device according to claim 10, wherein the intersection estimation processing comprises estimating at least a portion of the intersections based on at least one selected from a position of a peak of the cumulative projection component of the stroke data onto the first axis and a position of the peak of the cumulative projection component of the stroke data onto the second axis.

12. The device according to claim 10, wherein the intersection estimation processing comprises estimating at least a portion of the intersections based on at least one selected from a position of a bottom of the cumulative projection component of the stroke data onto the first axis and a position of a bottom of the cumulative projection component of the stroke data onto the second axis.

13. The device according to claim 7, wherein the axis estimation processing comprises estimating the second axis to minimize entropy of the cumulative projection component of the stroke data onto the second axis.

14. The device according to claim 7, wherein the axis estimation processing comprises estimating the first axis to minimize entropy of the cumulative projection component of the stroke data onto the first axis.

15. The device according to claim 10, wherein a peak value of a cumulative projection component of the ruled line data onto the first axis is higher than a first threshold.

16. The device according to claim 10, wherein a peak value of a cumulative projection component of the ruled line data onto the second axis is higher than a second threshold.

17. A handwritten document processing device, comprising:
an input/output controller configured to acquire stroke data of a handwritten document, the stroke data comprising a first portion and a second portion, the first portion extending along a first direction and comprising sets of first stroke data, the second portion comprising second stroke data; and
a processor configured to derive first table data based on the stroke data and supply the first table data to the input/output controller, the first table data comprising a first ruled line and first cell data, the first ruled line corresponding to the first portion, the first cell data corresponding to the second portion,
the sets of first stroke data being separated from each other along the first direction,
the first ruled line extending along the first direction.

18. The device according to claim 17, wherein a space between the sets of first stroke data is shorter than a length of the second portion along the first direction.

19. A handwritten document processing method of a processing device, comprising:
acquiring stroke data of a handwritten document, the stroke data comprising a first portion, a second portion, and a third portion, the first portion comprising first stroke data, the second portion comprising second stroke data, the third portion comprising third stroke data; and
deriving first table data based on the stroke data, the first table data comprising a first ruled line, first cell data, second cell data, and a second ruled line, the first ruled line corresponding to the first portion, the first cell data corresponding to the second portion, the second cell data corresponding to the third portion, the second ruled line provided between the first cell data and the second cell data.

20. A computer readable non-transitory storage medium comprising a handwritten document processing program, configured to
cause a computer to acquire stroke data of a handwritten document, the stroke data comprising a first portion, a second portion, and a third portion, the first portion comprising first stroke data, the second portion comprising second stroke data, the third portion comprising third stroke data, and
cause the computer to derive first table data based on the stroke data, the first table data comprising a first ruled line, first cell data, second cell data, and a second ruled line, the first ruled line corresponding to the first portion, the first cell data corresponding to the second portion, the second cell data corresponding to the third portion, the second ruled line provided between the first cell data and the second cell data.
